(19) United States
(12) Patent Application Publication
(10) Pub. No.: US 2024/0195936 A1
(43) Pub. Date: Jun. 13, 2024

(54) IMAGING SYSTEM, IMAGING TERMINAL, AND SERVER

(71) Applicant: FUJIFILM Corporation, Tokyo (JP)

(72) Inventor: Atsushi MISAWA, Saitama (JP)

(73) Assignee: FUJIFILM Corporation, Tokyo (JP)

(21) Appl. No.: 18/583,873

(22) Filed: Feb. 22, 2024

Related U.S. Application Data
(63) Continuation of application No. PCT/JP2022/027790, filed on Jul. 15, 2022.

(30) Foreign Application Priority Data
Aug. 30, 2021 (JP) 2021-140046

(51) Int. Cl. H04N 5/91; H04N 7/18

(52) U.S. Cl. CPC H04N 5/91; H04N 7/183

(57) ABSTRACT

An imaging system includes: imaging terminals; and a server, in which the imaging terminal includes an imaging unit that includes an image sensor and outputs imaging data, a first communication unit that transmits the imaging data output from the imaging unit to the server, a first image processing engine that performs image processing on the imaging data output from the imaging unit, and a memory that stores an image subjected to the image processing by the first image processing engine, and the server includes a second communication unit that receives the imaging data transmitted from the imaging terminal, and a second image processing engine that performs image processing on the received imaging data and generates an image for recording, the second image processing engine being different from the first image processing engine of the imaging terminal.

### CROSS-REFERENCE TO RELATED APPLICATIONS

The present application is a Continuation of PCT International Application No. PCT/JP2022/027790 filed on Jul. 15, 2022 claiming priority under 35 U.S.C § 119(a) to Japanese Patent Application No. 2021-140046 filed on Aug. 30, 2021. Each of the above applications is hereby expressly incorporated by reference, in its entirety, into the present application.

### BACKGROUND OF THE INVENTION

### 1. Field of the Invention

The present invention relates to an imaging system, an imaging terminal, and a server, and particularly relates to a technique for performing image processing on unprocessed data imaged and acquired by the imaging terminal in a server on a network.

### 2. Description of the Related Art

A digital camera system described in JP2003-87618A is configured of a digital camera (digital camera integrated-type mobile phone) and a server center communicating via the digital camera and the Internet.

The digital camera includes an imaging unit, a temporary storage unit that stores RAW data output from the imaging unit in response to a shutter release means, and a communication means that communicates wirelessly without compressing the RAW data in the temporary storage unit. A server center includes a communication means that receives RAW data, a compressing means that compresses the received RAW data, and a storage means that stores the compressed compression signal. In addition, the server center includes an interpolation means that creates a color-specific digital image signal by interpolating the received RAW data, and a white balance adjustment means.

With the digital camera system, the server center handles image processing or the like with respect to RAW data, thereby making it possible to provide a digital camera with a high performance at a low cost.

On the other hand, a digital camera system described in JP2003-87618A always performs image processing on RAW data in the server center. Therefore, there is a problem that a camera becomes difficult to use.

In JP2019-54536A, an electronic device that solves the above problem is proposed.

The electronic device described in JP2019-54536A includes a processing unit that processes an imaging signal imaged by an imaging unit, a communication unit that is able to transmit the imaging signal (RAW data) imaged by the imaging unit to a server, and a determination unit that determines whether or not to transmit the RAW data to the server according to a setting of imaging of the imaging unit.

The determination unit determines not to transmit the RAW data to the server, in a case where a wireless communication with the server is not available and a temperature of an imaging element is a specified value or lower, and determines to transmit the RAW data to the server in a case where the wireless communication with the server is available and a video is recorded to a recording medium in the electronic device or in a case where the temperature of the imaging element exceeds the specified value.

A first application specific integrated circuit (ASIC) in the electronic device performs various image processing on the RAW data in a case where the RAW data is not transmitted to the server. On the other hand, the server performs, in a case where the RAW data is received from the electronic device, the image processing on the received RAW data to by a second ASIC of the server, and generates a video (also serves as an image for live view) for recording.

That is, the electronic device described in JP2019-54536A determines whether or not to transmit the RAW data to the server by a communication status, a heat-generation state of the imaging element, or the like, and performs a image processing on the RAW data by the first ASIC in the electronic device or the second ASIC of the server in accordance with the determination. Note that, the second ASIC of the server equivalent to the first ASIC of the electronic device is used.

### SUMMARY OF THE INVENTION

An embodiment according to the technique of the present disclosure provides an imaging system capable of reducing a cost and improving performance of an imaging terminal, an imaging terminal, and a server.

An imaging system according to a first aspect of the present invention includes at least one or more imaging terminals; and a server, in which the imaging terminal includes an imaging unit that includes an image sensor and outputs imaging data, a first communication unit that transmits the imaging data output from the imaging unit to the server, a first image processing engine that performs image processing on the imaging data output from the imaging unit, and a memory that stores an image subjected to the image processing by the first image processing engine, and the server includes a second communication unit that receives the imaging data transmitted from the first communication unit of the imaging terminal, and a second image processing engine that performs image processing on the received imaging data and generates an image for recording, the second image processing engine being different from the first image processing engine of the imaging terminal.

In the imaging system according to a second aspect of the present invention, it is preferable that the second image processing engine generates a live view image based on continuously received imaging data.

In the imaging system according to a third aspect of the present invention, it is preferable that the server records the image for recording generated by the second image processing engine to an image recording unit.

In the imaging system according to a fourth aspect of the present invention, it is preferable that the second image processing engine has a technical specification higher than a technical specification of the first image processing engine.

In the imaging system according to a fifth aspect of the present invention, it is preferable that the first image processing engine and the second image processing engine have different image processing performance.

In the imaging system according to a sixth aspect of the present invention, it is preferable that the first image processing engine is capable of the image processing on a smaller amount of information per pixel than the second image processing engine.

In the imaging system according to a seventh aspect of the present invention, it is preferable that the first image processing engine has a different number of gradation bits or a different number of processing bits from the second image processing engine.

In the imaging system according to an eighth aspect of the present invention, it is preferable that the first image processing engine has only a part among functions that are able to perform the image processing with compared to the second image processing engine.

In the imaging system according to a ninth aspect of the present invention, it is preferable that the first image processing engine is capable of performing the image processing on a smaller number of pixels of an image than the second image processing engine.

In the imaging system according to a tenth aspect of the present invention, it is preferable that the first image processing engine has an arithmetic element having smaller thermal design power than the second image processing engine.

In the imaging system according to an eleventh aspect of the present invention, it is preferable that the first image processing engine has an arithmetic element having a smaller number of transistors than the second image processing engine.

In the imaging system according to a twelfth aspect of the present invention, it is preferable that the first image processing engine has a smaller number of processor cores than the second image processing engine.

In the imaging system according to a thirteenth aspect of the present invention, it is preferable that the first image processing engine includes an arithmetic element having a lower operation clock frequency than the second image processing engine.

In the imaging system according to a fourteenth aspect of the present invention, it is preferable that the first image processing engine includes an arithmetic element having a lower rated operating current value than the second image processing engine.

In the imaging system according to a fifteenth aspect of the present invention, it is preferable that the first image processing engine has a smaller cache memory capacity than the second image processing engine.

In the imaging system according to a sixteenth aspect of the present invention, it is preferable that the first image processing engine has a configuration in which the number of executable commands is smaller than the second image processing engine.

In the imaging system according to a seventeenth aspect of the present invention, it is preferable that the first image processing engine has a configuration in which the number of calculation units for executing a calculation command is smaller than the second image processing engine.

In the imaging system according to an eighteenth aspect of the present invention, it is preferable that the first image processing engine has a built-in graphics function, and the second image processing engine has an extended graphics function.

In the imaging system according to a nineteenth aspect of the present invention, it is preferable that the imaging terminal transmits, in a case where an imaging instruction of a static image by a user operation is received, imaging instruction information from the first communication unit to the server, and the second image processing engine performs the image processing on imaging data corresponding to the imaging instruction information among continuous imaging data, and generates a static image for recording, in a case where the imaging instruction information is received via the second communication unit.

In the imaging system according to a twentieth aspect of the present invention, it is preferable that the imaging terminal transmits recording instruction information or recording end instruction information from the first communication unit to the server in a case where a recording instruction or a recording end instruction of a video by a user operation is received, and the second image processing engine performs, in a case where the recording instruction information or the recording end instruction information is received via the second communication unit, image processing on imaging data from receiving recording instruction information to receiving recording end instruction information among the continuous imaging data, and generates a video for recording.

In the imaging system according to a twenty-first aspect of the present invention, it is preferable that the imaging terminal transmits terminal information indicating the imaging terminal to the server at a time of starting communication with the server, the server acquires, in a case where the terminal information is received, RAW development information corresponding to the received terminal information, and the second image processing engine performs image processing of performing RAW development on the imaging data based on the acquired RAW development information.

In the imaging system according to a twenty-second aspect of the present invention, it is preferable that the server transmits the live view image generated by the second image processing engine to the imaging terminal via the second communication unit, and the imaging terminal displays the live view image on a display of the imaging terminal in a case where the live view image is received from the server via the first communication unit.

In the imaging system according to a twenty-third aspect of the present invention, it is preferable that the first image processing engine is operated during a period in which communication between the imaging terminal and the server is not available.

In the imaging system according to a twenty-fourth aspect of the present invention, it is preferable that the first image processing engine generates a live view image based on the imaging data continuously output from the image sensor during a period in which communication between the imaging terminal and the server is not available, and the imaging terminal displays the live view image generated by the first image processing engine on a display during the period in which communication between the imaging terminal and the server is not available.

In the imaging system according to a twenty-fifth aspect of the present invention, it is preferable that the imaging terminal communicates with the server, receives an image designated by a user operation among the images recorded in the image recording unit from the server, and displays the received image on a display or stores the received image in the memory.

An imaging system according to a twenty-sixth aspect of the present invention includes at least one or more imaging terminals; and a server, in which the imaging terminal includes an imaging unit that includes an image sensor and outputs imaging data, and a first communication unit that transmits the imaging data output from the imaging unit to the server, the server includes a second communication unit that receives the imaging data transmitted from the first communication unit of the imaging terminal, and an image processing engine that performs image processing on the received imaging data to generate an image for recording, data corresponding to one pixel of the image sensor of the imaging data has gradation of a maximum number of bits converted by an analog-to-digital conversion circuit, the image processing engine generates a live view image based on continuously received imaging data, the server transmits the generated live view image to the imaging terminal via the second communication unit, and the imaging terminal displays the live view image on a display of the imaging terminal in a case where the live view image is received from the server via the first communication unit.

An imaging terminal according to a twenty-seventh aspect of the present invention may include the imaging system according to any one aspect of the first aspect to the twenty-fifth aspect.

A server according to a twenty-eighth aspect of the present invention may include the imaging system according to any one aspect of the first aspect to the twenty-fifth aspect.

### BRIEF DESCRIPTION OF THE DRAWINGS

FIG. 1 is a diagram showing a system configuration of an imaging system according to the present invention.

FIG. 2 is a block diagram showing an embodiment of an imaging terminal constituting the imaging system.

FIG. 3 is a block diagram showing an embodiment of a server constituting the imaging system.

FIG. 4 is a block diagram showing an embodiment of a primary image processing circuit of a front-end LSI.

FIG. 5 is a block diagram showing an embodiment of a secondary image processing circuit of the front-end LSI.

FIG. 6 is a schematic diagram showing a first embodiment of an imaging system according to the present invention.

FIG. 7 is a schematic diagram showing a second embodiment of the imaging system according to the present invention, and is a diagram in a case where communication between the imaging terminal and the server is normal.

FIG. 8 is a schematic diagram showing a second embodiment of the imaging system according to the present invention, and is a diagram in a case where communication between the imaging terminal and the server is not available.

FIG. 9 is a schematic diagram showing a third embodiment of the imaging system according to the present invention.

FIG. 10 is a schematic diagram showing a fourth embodiment of the imaging system according to the present invention.

FIG. 11 is a flowchart showing an operation of the imaging terminal in the imaging system, and is a flowchart showing an operation in an imaging mode.

FIG. 12 is a flowchart showing an operation of the imaging terminal in the imaging system, and is a flowchart showing an operation in a playback mode.

FIG. 13 is a flowchart showing an operation of the server in the imaging system.

### DESCRIPTION OF THE PREFERRED EMBODIMENTS

Hereinafter, preferred embodiments of an imaging system, an imaging terminal, and a server according to the present invention will be described with reference to the accompanying drawings.

### Overview of Imaging System

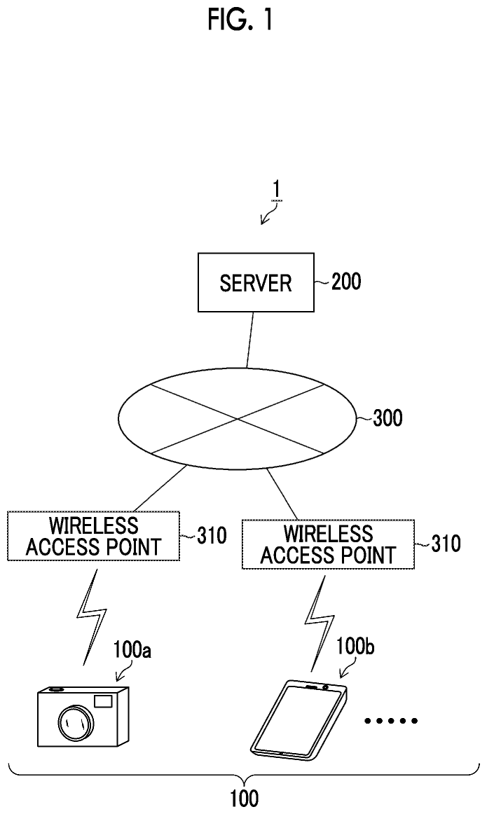

FIG. 1 is a diagram showing a system configuration of an imaging system according to the embodiment of the present invention.

As shown in FIG. 1, the imaging system 1 is composed of at least one or more imaging terminals 100 and a server 200.

The imaging terminal 100 is a digital camera 100a with a communication function, a smartphone 100b with a camera built therein, or other various gadgets with a camera (a drone, a fixed roof camera, or the like).

The imaging terminal 100 is constantly connected to the server 200 via the wireless access point 310 and the network 300 during activation, transmits imaging data continuously output from the imaging unit to the server 200 during imaging, receives a user-desired image (playback image) from among images stored in the server 200 at the time of playback, and displays the playback image on a liquid crystal display (LCD). The imaging data output from the imaging unit is data before image processing and hereinafter, is referred to as “RAW data”.

In addition, the imaging terminal 100 receives a live view image generated from the continuous RAW data during the imaging from the server 200, and displays the received live view image on an electronic view finder (EVF) or the LCD.

Further, the imaging terminal 100 is prepared for a case where communication with the server 200 is not available or difficult (including a case where communication is unstable) by being provided with an image processing engine (first image processing engine) that enables imaging offline.

As a method of identifying a case where the communication is not available or difficult to perform between the imaging terminal 100 and the server 200, even in the detection of a communication environment such as the radio wave intensity or the check of a communication status such as the data transmission and reception error check, it does not matter whether the method is one of methods of detecting a user operation in which the communication is determined to be difficult by a user, or a combination thereof.

In addition, the image processing can be divided into primary image processing performed as a pre-stage at the time of RAW development, such as characteristic correction unique to an imaging element, such as defect correction or a sensitivity error correction for each pixel, and a secondary image processing performed at the time of RAW development or after the RAW development. However, according to one example of the present specification, in a normal operation state, imaging data that is transmitted to a network 300 by the imaging terminal 100 of the imaging system 1 is transmitted in a state of “output data of an image sensor that is not subjected to any image processing” or “data that is not subjected to a part of the primary image processing”. Accordingly, in a state where the image processing engine (second image processing engine) of the server 200 on the network, a superiority of the second image processing engine on the network can be utilized by, for example, performing the primary image processing having higher functions and performance by the second image processing engine on the network, improving a continuous shooting speed by increasing a processing speed, or improving an image quality by performing more complicated and accurate image processing.

The content of the image processing performed as the primary image processing includes, other than the defect correction or the sensitivity error correction for each pixel, a tuning processing that is performed to obtain a preferable image quality by processing a color or brightness for each pixel or area. However, the detailed content of the processing includes those that are not disclosed by the manufacturer as know-how. Here, it refers to all the data in which processing for improving image quality is performed on digital data before the RAW development.

The server 200 comprises a second image processing engine that is different from the first image processing engine of the imaging terminal 100 and an image recording unit, and performs bidirectional communication with one or a plurality of imaging terminal 100 via the network 300 and wireless access point 310 to exchange necessary data.

The server 200 receives the continuous RAW data from the imaging terminal 100, generates the live view image or an image for recording from the continuous RAW data by the second image processing engine, transmits the generated live view image to the imaging terminal 100, and stores the image for recording in an image recording unit of the server 200. The image recording unit may be comprised in a server (for example, a data server) that is physically different from the server 200 having the second image processing engine.

The RAW data of the present example is not limited to static image data in a RAW file format, and is the imaging data before the RAW development. Therefore, the “continuous RAW data” can be realized by continuously transmitting the data included in the RAW file format, but refers to broader and continuous output data from the image sensor. Therefore, the RAW data is expressed as “continuous RAW data” including streaming data that is not subjected to a file format in a unit of a static image and a data column subjected to analog-to-digital (A/D) conversion.

According to the most representative example, the “continuous RAW data” transmitted as the continuous data is input to the second image processing engine as a data column that is not subjected to a file format in a unit of a static image, is subjected to image processing and a RAW development by the first image processing engine, and is converted into a video data format for live view display and then transmitted as a live view output. In addition, a continuous RAW data for recording is converted a file format set by a user in advance by the second image processing engine, and then is output as a static image or a video file.

The continuous data may be, for example, continuous data in which only the bit rate is converted without performing the primary image processing, such as 16-bit video RAW data.

The server 200 transmits the image stored in the image recording unit to the imaging terminal 100 as a playback image in response to the request from the imaging terminal 100.

In this way, by performing the image processing on the image sensor output of the imaging terminal 100 by the second image processing engine of the server 200, a lot of advantages can be expected that not only the size, weight, and cost of the imaging terminal 100 can be reduced, but also the power consumption decreases and the hours of use increases, the development is facilitated and the variation of the imaging terminal 100 is easily developed, the latest update can be reflected in the second image processing engine without replacing the imaging terminal 100 (this can also be performed by a machine learning), a relationship between the input (RAW data) and the output of the second image processing engine can be acquired on the network, a large amount of development data (including training data used in a machine learning) for developing a better image processing engine, waste can be eliminated by time-sharing the image processing engine on the network and a high-performance image processing engine can be used at a low cost, a peripheral circuit (particularly, a memory for a continuous shooting with a low usage frequency) of the image processing engine can be shared, and thus, a limitation on the number of the continuous shooting is substantially removed in a case where an efficient sharing is performed, and the like.

### <Imaging Terminal>

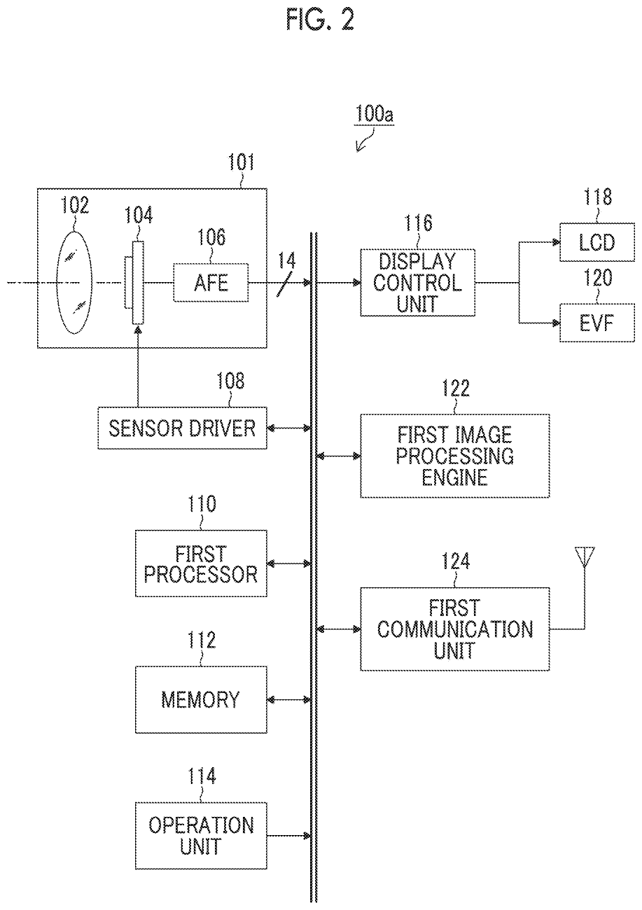

FIG. 2 is a block diagram showing an embodiment of an imaging terminal constituting the imaging system.

The imaging terminal shown in FIG. 2 is a digital camera 100a with a communication function.

As shown in FIG. 2, the digital camera 100a comprises an imaging unit 101, a sensor driver 108, a first processor 110, a memory 112, an operation unit 114, a display control unit 116, an LCD 118, an EVF 120, a first image processing engine 122, and a first communication unit 124.

The imaging unit 101 has an imaging lens 102, an image sensor 104, and an analog front end (AFE) 106.

The imaging lens 102 may be a lens integrated with a camera body or an interchangeable lens that is attachable to and detachable from the camera body.

The image sensor 104 is composed of a complementary metal-oxide semiconductor (CMOS) type color image sensor. The image sensor 104 is not limited to the CMOS type, but may be a charge coupled device (CCD) type image sensor.

In the image sensor 104, color filters of red (R), green (G), and blue (B) are arranged in a periodic color array (for example, a Bayer array, X-Trans (registered trademark), or the like) on a plurality of pixels composed of photoelectric conversion elements (photodiode) two-dimensionally arranged in the x-direction (horizontal direction) and the y-direction (vertical direction), and microlenses are disposed on each photodiode.

The image sensor 104 converts an optical image of the subject formed on a light-receiving surface of the image sensor 104 by the imaging lens 102 into an electric signal. An electric charge corresponding to an amount of incident light is accumulated in each pixel of the image sensor 104, and an electric signal corresponding to an amount of electric charge (signal charge) accumulated in each pixel is read out as an image signal from the image sensor 104.

The AFE 106 performs various pieces of analog signal processing on an analog image signal output from the image sensor 104. The AFE 106 includes a correlated double sampling circuit, an automatic gain control (AGC) circuit, and an analog-to-digital conversion circuit (A/D conversion circuit) (all of which are not shown). The correlated double sampling circuit performs correlated double sampling processing on the analog signal from the image sensor 104 to remove noise caused by resetting the signal charge. The AGC circuit amplifies the analog signal from which noise is removed by the correlated double sampling circuit, such that a signal level of the analog signal falls within an appropriate range. The A/D conversion circuit converts the image signal, which is gain-adjusted by the AGC circuit, into a digital signal.

The digital signal that is read out from the image sensor 104 and output from the AFE 106 is data (B, G, R data) of pixels of B, G, and R corresponding to a color filter array of the image sensor 104, and is referred to as “RAW data” below. The RAW data is point-sequential mosaic image data in which B, G, and R data are arrayed corresponding to the color filter array.

In a case where the image sensor 104 is a CMOS type image sensor, the AFE 106 is often incorporated in the image sensor 104.

In addition, in the present specification, the analog signal processing by the AFE 106 is not referred to as image processing, and the signal processing on the digital signal after being converted into the digital signal by the A/D conversion circuit is defined as the image processing. Therefore, the RAW data output from the image sensor 104 (AFE 106) is data before the image processing.

The sensor driver 108 performs a control to read out an image signal from the image sensor 104 in response to a command from the first processor 110. In addition, the sensor driver 108 has an electronic shutter function of discharging (resetting) electric charges accumulated in each pixel of the image sensor 104 and starting exposure by an electronic shutter control signal from the first processor 110.

The first processor 110 is composed of a central processing unit (CPU) or the like, controls each unit in an integrated manner, and performs various types of processing in response to a user operation using the operation unit 114.

In addition, the first processor 110 performs an auto focus (AF) control and an automatic exposure (AE) control.

In a case where the AF control is performed, the first processor 110 calculates a numerical value required for the AF control based on the digital image signal. In a case of so-called contrast AF, for example, an integrated value (focus evaluation value) of high-frequency components of the G data in a predetermined AF area is calculated. The first processor 110 moves a focus lens included in the imaging lens 102 to a position (that is, a position at which a contrast is maximized) at which the focus evaluation value is maximized during the AF control. The AF is not limited to the contrast AF, for example, in a case where the image sensor 104 includes a phase-difference detection pixel, the defocus amount is detected based on the pixel data of the phase-difference detection pixel, and may perform phase difference AF in which the focus lens is moved, such that the defocus amount becomes zero.

In a case where the AE control is performed, the first processor 110 detects a brightness of a subject (subject brightness), and calculates a numerical value (exposure value (EV value)) required for AE control corresponding to the subject brightness. The first processor 110 can determine an F-number, a shutter speed, and an ISO sensitivity from a predetermined program diagram based on the calculated EV value, and perform the AE control.

It is needless to say that the AF control and the AE control are automatically performed in a case where an auto mode is set by the operation unit 114, and the AF control and the AE control are not performed in a case where a manual mode is set.

The memory 112 includes a flash memory, a read-only memory (ROM), a random access memory (RAM), and the like. The flash memory and the ROM are non-volatile memories that store various programs, parameters, and the like including firmware.

The RAM functions as a work region for processing by the first processor 110, and also temporarily stores the firmware or the like stored in the non-volatile memory. It should be noted that a part (RAM) of the memory 112 may be built in the first processor 110.

The operation unit 114 includes a power switch, a shutter button, a MENU/OK key, a cross key, a play button, and the like.

The LCD 118 is provided on a rear surface of the camera body, and functions as a display that displays various menu screens in addition to displaying a live view image in the imaging mode and playing back and displaying a captured image in the playback mode. The EVF 120 can also perform the same display as the LCD 118. In the imaging mode, in a case where an eye is brought close to the EVF 120, the display is automatically switched to the display of the EVF 120 due to the action of an eye sensor (not shown), and in a case where the eye is apart from the EVF 120, the display is automatically switched to the display of the LCD 118.

The MENU/OK key in the operation unit 114 is an operation key having both a function as a menu button for performing a command to display a menu on a screen of the LCD 118 and a function as an OK button for performing a command to confirm, execute, and the like of a selected content.

The cross key is an operation unit that inputs instructions in four directions of up, down, right, and left, and functions as a button for selecting an item from a menu screen or instructing selection of various setting items from each menu. Up and down keys of the cross key function as zoom switches during the imaging or playback zoom switches during the playback mode. Left and right keys thereof function as frame advance (forward and reverse directions) buttons during the playback mode. The play button is a button for switching to the playback mode in which the image captured and recorded is displayed on the LCD 118.

The first image processing engine 122 operates in a case where communication with the server 200 is not available. The first image processing engine 122 performs image processing such as RAW development processing on the RAW data continuously read out from the imaging unit 101 to generate a live view image and an image for recording. The details of the first image processing engine 122 will be described below. In addition, the first processor 110 may perform the image processing instead of the first image processing engine 122 or a part of the first image processing function of the first image processing engine 122.

Here, the RAW data read out from the imaging unit 101 (image sensor 104) is continuous data that is continuously read out at a set frame rate (for example, 30 fps, 60 fps, or the like). Each of the B, G, and R data in the RAW data is data having gradations corresponding to the maximum number of bits (in the present example, 14 bits) of the A/D conversion circuit in the AFE 106.

The first communication unit 124 is constantly connected to the server 200 via the wireless access point 310 and the network 300 during the activation of the digital camera 100a, and performs bidirectional communication with the server 200. During the imaging, the first communication unit 124 transmits the imaging data (RAW data) to the server 200 before the image processing in a format of continuous data in which frames are continuous, and receives a live view image corresponding to the continuous data (RAW data in which frames are continuous) that is generated by image processing such as a RAW development processing by the server 200. In a case of playback, the first communication unit 124 transmits information regarding an image to be played back designated by a user operation and receives the image designated by the user operation from the server 200. The first communication unit 124 transmits a shutter release signal (imaging instruction information), terminal information indicating the digital camera 100a, and the like to the server 200, the details of which will be described later. In addition, although the first communication unit 124 is preferably the full-doubled wireless communication in which transmission and reception can be performed simultaneously, transmission and reception may be performed at the same time by using two or more wireless lines. In addition, the first communication unit 124 may have a configuration in which a transmission unit and a reception unit are different from each other (for example, light for uplink, radio waves for downlink, or the like).

### <Server>

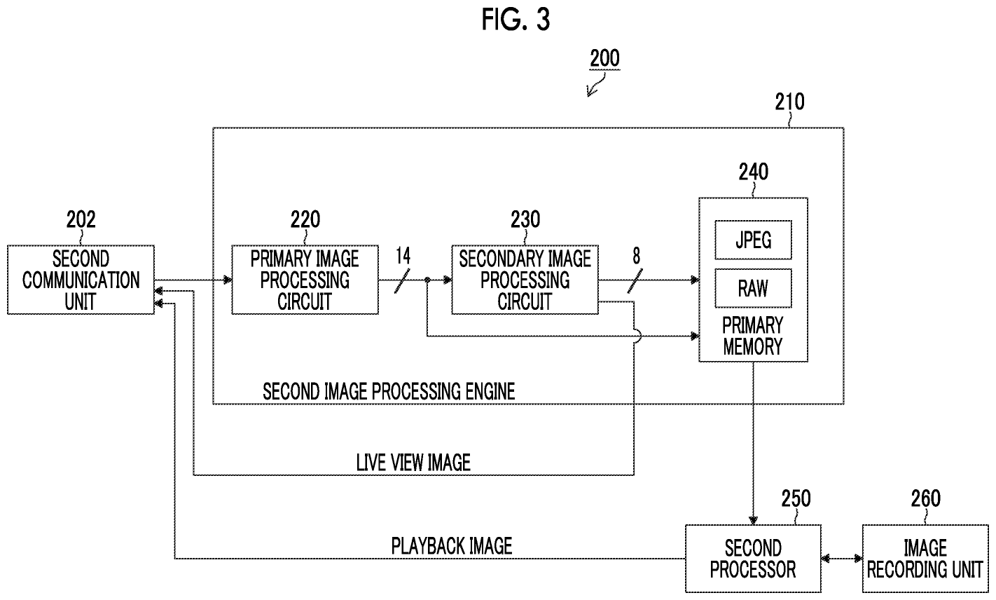

FIG. 3 is a block diagram showing an embodiment of a server constituting the imaging system.

The server 200 shown in FIG. 3 performs bidirectional communication with one or a plurality of imaging terminals 100 via the network 300 and a wireless access point 310, and has functions of image processing, image recording, and the like with respect to the imaging terminal 100.

The server 200 shown in FIG. 3 comprises a second communication unit 202, a second image processing engine 210, a second processor 250, and an image recording unit 260.

The second communication unit 202 performs bidirectional communication with the imaging terminal 100 via the network 300 and a wireless access point 310, receives continuous data from the imaging terminal 100, and transmits a live view image corresponding to the continuous data generated by the second image processing engine 210 to the imaging terminal 100. During the playback on the imaging terminal 100, the second communication unit 202 receives information related to an image to be played back, which is designated by a user operation, and transmits an image corresponding to the information to the imaging terminal 100. In addition, the second communication unit 202 receives a shutter release signal, the terminal information indicating the imaging terminal 100, and the like from the imaging terminal 100. In the present example, while the imaging terminal 100 as a communication destination is the digital camera 100a with a communication function, it is preferable that a plurality of second communication units 202 are provided, such that communication with a plurality of imaging terminals 100 can be performed without a time lag.

The second image processing engine 210 is an image processing engine of a different type from the first image processing engine (in the present example, the first image processing engine 122 of the digital camera 100a with the communication function) of the imaging terminal 100, and has a technical specification higher than a technical specification of the first image processing engine 122.

Conversely, the technical specification of the first image processing engine 122 is lower than the technical specification of the second image processing engine 210.

Specifically, in a case where the first image processing engine 122 and the second image processing engine 210 are compared, at least one or more of the following image processing performances differ.

(1) The first image processing engine 122 has a smaller amount of information per pixel on which the image processing is able to be performed with respect to the second image processing engine 210.

(2) The first image processing engine 122 has a different number of gradation bits or a different number of processing bits with respect to the second image processing engine 210. For example, the number of gradation bits of the data processed by the first image processing engine 122 can be set to 8 bits, and the number of gradation bits of the data processed by the second image processing engine 210 can be set to 14 bits. Further, it is assumed that the image processing by the first image processing engine 122 can be image processing on data having 8-bit gradation, and the image processing by the second image processing engine 210 can include image processing on data having 14-bit gradation.

(3) The first image processing engine 122 has only a part of functions that are able to perform the image processing with respect to the second image processing engine 210. For example, an image compression processing function or the like is not provided.

(4) The first image processing engine 122 has a small number of pixels of an image on which the image processing is able to be performed with respect to the second image processing engine 210.

(5) The first image processing engine 122 includes an arithmetic element having smaller thermal design power with respect to the second image processing engine 210. That is, the first image processing engine 122 has smaller power consumption and a smaller heat generation amount than the second image processing engine 210.

(6) The first image processing engine 122 includes an arithmetic element having a smaller number of transistors with respect to the second image processing engine 210.

(7) The first image processing engine 122 has a smaller number of processor cores with respect to the second image processing engine 210.

(8) The first image processing engine 122 includes an arithmetic element having a lower operation clock frequency with respect to the second image processing engine 210.

(9) The first image processing engine 122 includes an arithmetic element having a lower rated operating current value with respect to the second image processing engine 210.

(10) The first image processing engine 122 has a smaller cache memory capacity with respect to the second image processing engine 210.

(11) The first image processing engine 122 has a configuration in which the number of executable commands is smaller with respect to the second image processing engine 210.

(12) The first image processing engine 122 has a configuration in which the number of calculation units for executing the calculation command is smaller with respect to the second image processing engine 210.

(13) The first image processing engine 122 has a built-in graphics function, and the second image processing engine 210 has an extended graphics function.

The difference in the technical specification includes, in addition to the image processing performance, a difference in a width of a programmable region and a flexibility of an internal processing (different from a superiority of the image processing performance itself), a difference in a process rule although an architecture and a circuit scale are the same, a difference in a power consumption due to the difference in the process rule, a difference in functions and performances of heat measures, such as sensing function of a temperature detection, saving a space due to a difference in a chip size, or the like, but is not limited thereto.

The second image processing engine 210 of the present example comprises a front-end large-scale integration (LSI) 239 and a primary memory 240 as an internal memory thereof, and the front-end LSI 239 includes a primary image processing circuit 220 and a secondary image processing circuit 230.

The primary image processing circuit 220 of the front-end LSI 239 inputs continuous data of the RAW data transmitted from the imaging terminal 100 and received by the second communication unit 202, performs the primary image processing on the RAW data of each frame that is input in order, and generates RAW data that can be used for RAW data recording to output the RAW data to the secondary image processing circuit 230 and the primary memory 240.

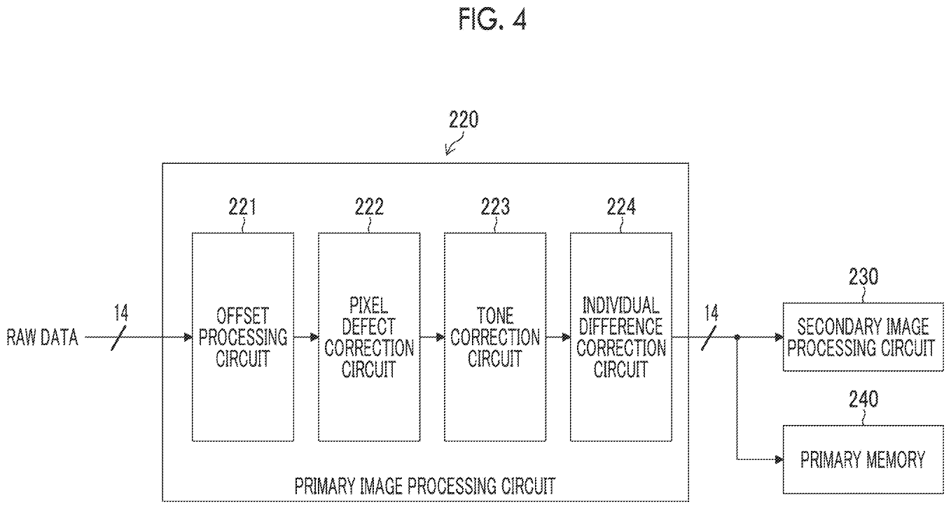

FIG. 4 is a block diagram showing an embodiment of the primary image processing circuit of the front-end LSI.

The primary image processing circuit 220 shown in FIG. 4 comprises an offset processing circuit 221, a pixel defect correction circuit 222, a tone correction circuit 223, and an individual difference correction circuit 224.

The RAW data received by the second communication unit 202 is applied to the offset processing circuit 221 of the primary image processing circuit 220. The B, G, and R data in the RAW data are data each having 14-bit gradation value.

The offset processing circuit 221 performs offset processing on the input RAW data. The offset processing circuit 221 is a processing unit that corrects a dark current component of a sensor output of the image sensor 104, calculates an average value of pieces of pixel data corresponding to a plurality of light-shielded pixels (optical black pixels) of the image sensor 104, and performs an operation of subtracting the calculated average value from the input RAW data. The RAW data subjected to the offset processing is output to the pixel defect correction circuit 222.

The pixel defect correction circuit 222 is a correction circuit that corrects a unique pixel defect (scratch) of the image sensor 104.

The server 200 stores various pieces of correction information and information (RAW development information) necessary for RAW development in a memory (not shown) according to the terminal information (for example, product name+serial number) of the imaging terminal 100, and by receiving the terminal information from the imaging terminal 100 at a time of starting communication with the imaging terminal 100, correction information and RAW development information corresponding to the imaging terminal 100 can be read out from the memory and used. The correction information and the RAW development information for each imaging terminal 100 can be acquired in advance from the imaging terminal 100 or downloaded from the server of the manufacturer of the imaging terminal 100 based on the terminal information, and stored in the memory. In addition, the RAW development information includes information such as a color filter array, the number of pixels, and an effective pixel region of the image sensor.

The pixel defect correction circuit 222 acquires information on a defective pixel of the image sensor 104 (position information of the defective pixel) based on the terminal information of the imaging terminal 100, and in a case where R, G, or B data corresponding to the defective pixel is input, performs interpolation calculation on pixel data having the same color in the vicinity of the position of the defective pixel, and outputs the pixel data subjected to interpolation calculation instead of data corresponding to the defective pixel. In a case where the image sensor 104 includes a phase-difference detection pixel, an interpolation calculation is performed in the same manner on the data at the position of the phase-difference detection pixel, and the interpolated data is output instead of the data of the phase-difference detection pixel.

The tone correction circuit 223 performs color correction for correcting spectral characteristics of the output data of B, G, and R of the image sensor 104, and performs matrix calculation of three inputs of the input R, G, and B data and three outputs of B, G, and R. In a case where matrix coefficients of a 3×3 matrix are provided, the data of three colors of B, G, and R, which are subjected to color tone correction, can be obtained from data of three colors of the input R, G, and B data. In this case, the linear matrix conversion is performed by using a matrix coefficient of improving the color reproducibility, which corresponds to the terminal identification information of the imaging terminal 100.

The individual difference correction circuit 224 is a portion that performs correction corresponding to an individual difference of the image sensor 104. In a case of the imaging terminal 100 which is the same product, in order to obtain the same color reproduction and the image quality as that of the reference imaging terminal, an adjustment value corresponding to the spectral sensitivity characteristic of each individual image sensor 104 is used, the adjustment value is multiplied by the B, G and R data, and outputs the B, G, and R data having the same color reproduction and the image quality regardless of the individual difference of the image sensor 104.

The RAW data processed by the primary image processing circuit 220 is output to the secondary image processing circuit 230 and the primary memory 240. The content of the image processing and the order of the processing on the RAW data by the primary image processing circuit 220 are not limited to the above embodiment. In addition, the RAW data processed by the primary image processing circuit 220 is data before the RAW development processing, and the B, G, and R data have 14-bit gradation.

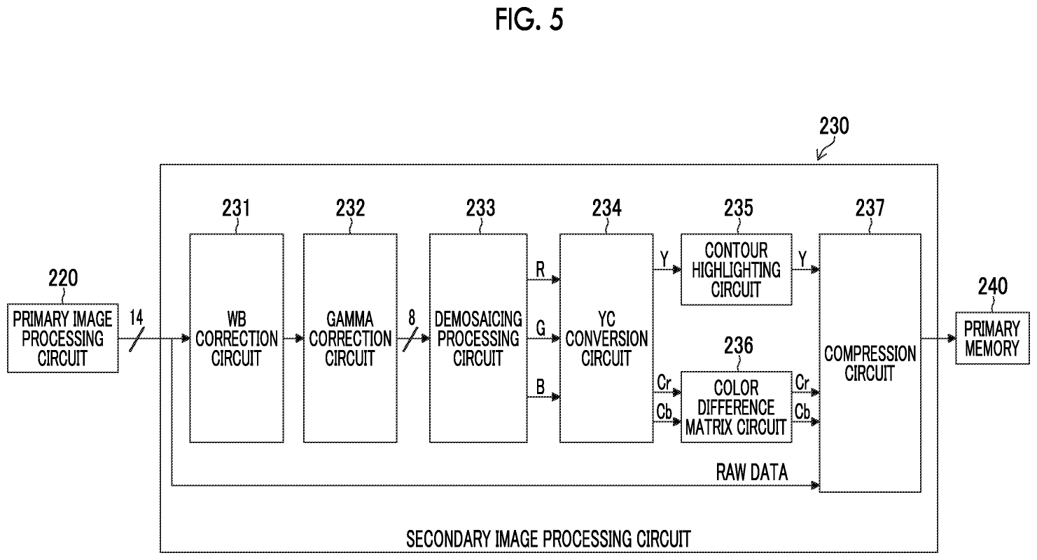

FIG. 5 is a block diagram showing an embodiment of a secondary image processing circuit of the front-end LSI.

The secondary image processing circuit 230 shown in FIG. 5 comprises a white balance (WB) correction circuit 231, a gamma correction circuit 232, a demosaicing processing circuit 233, a contour highlighting circuit 235, a color difference matrix circuit 236, and a compression circuit 237.

The RAW data processed by the primary image processing circuit 220 is added to the WB correction circuit 231 of the secondary image processing circuit 230.

The WB correction circuit 231 automatically discriminates a type of a light source such as “sunny”, “cloudy”, “shade”, “light bulb”, or “fluorescent lamp”, and the imaging scene from the B, G, and R data of the input RAW data, amplifies the B, G, and R data by using a WB gain for each of B, G, and R data predetermined according to the type of the light source, and performs white balance correction. The B, G, and R data subjected to the white balance correction are output to the gamma correction circuit 232.

The gamma correction circuit 232 includes, for example, a gamma correction table for each of B, G, and R data, and performs a gradation correction (gamma correction) on the input B, G, and R data such that a halftone of linear data increases corresponding to gamma characteristic by the gamma correction table having gamma characteristic corresponding to each of the input B, G, and R data. Further, the gamma correction circuit 232 of the present example converts 14-bit B, G, and R data into 8-bit B, G, and R data. The 8-bit B, G, and R data that are gamma-corrected by the gamma correction circuit 232 are output to the demosaicing processing circuit 233.

The demosaicing processing circuit 233 generates color data of the insufficient color at each pixel position of the image sensor 104 from each color data of point-sequential B, G, and R data, which is mosaic image data, corresponding to the color filter array of the image sensor 104 by interpolation, and simultaneously outputs the B, G, and R data at each pixel position. That is, the demosaicing processing circuit 233 converts the point-sequential B, G, and R data into simultaneous B, G, and R data, and outputs the simultaneous B, G, and R data to the YC conversion circuit 234.

The YC conversion circuit 234 converts the simultaneous B, G, and R data into brightness data (Y) and color difference data (Cr, Cb), outputs the brightness data (Y) to the contour highlighting circuit 235, and outputs the color difference data (Cr, Cb) to the color difference matrix circuit 236. The contour highlighting circuit 235 performs processing of highlighting a contour portion (a portion with a large change in brightness) of the brightness data (Y). The color difference matrix circuit 236 performs a matrix calculation of the input color difference data (Cr, Cb) and 2-row×2-column color correction matrix coefficients, and performs color correction for realizing favorable color reproducibility.

In this way, the secondary image processing circuit 230 generates image data that can be displayed from the RAW data by performing various types of image processing (RAW development processing) on the RAW data.

The compression circuit 237 performs compression processing on the brightness data (Y) output from the contour highlighting circuit 235 and the color difference data (Cr, Cb) output from the color difference matrix circuit 236. A static image is compressed, for example, in a joint photographic coding experts group (JPEG) format, and video is compressed, for example, in an H.264 format. The compressed image data is held in the primary memory 240.

In addition, the RAW data processed by the primary image processing circuit 220 is added to the compression circuit 237, and the compression circuit 237 compresses the RAW data and then outputs the RAW data to the primary memory 240. As the compression of the RAW data, it is preferable to perform reversible compression (lossless compression). As shown in FIG. 3, the RAW data may be directly output from the primary image processing circuit 220 to the primary memory 240 and may be held in the primary memory 240 without being compressed (uncompressed).

Returning to FIG. 3, the second image processing engine 210 receives the continuous data of the RAW data from the imaging terminal 100 (in the present example, the digital camera 100a) and transmits the live view image corresponding to the continuous data generated by the second image processing engine 210 to the digital camera 100a. Specifically, an image, which is an image of each frame of each image processing corresponding to the continuous data, consisting of brightness data (Y) output from the contour highlighting circuit 235 of the secondary image processing circuit 230 shown in FIG. 4, color difference data (Cr, Cb) output from the color difference matrix circuit 236, or B, G, and R data converted from the brightness data (Y) and the color difference data (Cr, Cb) is output to the second communication unit 202 as a live view image, and is transmitted from the second communication unit 202 to the digital camera 100a via the network 300 and the wireless access point 310.

After the continuous data is transmitted to the digital camera 100a, a live view image is generated by performing the image processing in the server 200, and a time until the live view image is transmitted to the digital camera 100a is mostly a time required for transmission and reception of data. However, in the 5th generation (5G) mobile communication system, it is possible to realize an ultra-low delay in which a delay time from the transmission to the reception of the data is shortened to about 1 millisecond, and the delay in this part is so short that a human cannot experience the delay.

Accordingly, the digital camera 100a can display the live view image on the LCD 118 or the EVF 120 in substantially real time. In addition, a next-generation 6G mobile communication system that is faster than the 5G mobile communication system is introduced after 2027. In a case where such a communication speed is realized, a communication speed that is equivalent to a bus transfer speed in the current imaging terminal can be realized, and a time lag between the imaging terminal and a server on the network is further reduced, so that a live view image can be displayed in a more real time.

In the digital camera 100a, in a case where the shutter button is operated (in a case where the imaging instruction of the static image by the user operation is received), the imaging terminal 100 performs the AF control and the AE control for static image recording, transmits RAW data for static image recording as one frame of the continuous data, and transmits a shutter release signal (imaging instruction information) by interrupting the continuous data.

Meanwhile, the second processor 250 constantly waits for a shutter release signal, which is obtained by operating the shutter button by the user, to be transmitted from the digital camera 100a. In a case where the shutter release signal is received via the second communication unit 202, the second processor 250 acquires an image data, which is RAW data for static image recording, which is specified by the shutter release signal, subjected to image processing by the second image processing engine 210 from the second image processing engine 210, and records the image data in the image recording unit 260.

The second processor 250 records a static image file, in which RAW data for static image recording is subjected to RAW development processing by the second image processing engine 210, which is an image file having JPEG-compressed image data and is held in the primary memory 240, in the image recording unit 260. In this case, the second processor 250 preferably records the static image file in an image folder (folder in the image recording unit 260) related to the terminal information or the like, based on the terminal information or user information of the digital camera 100a.

In addition, the second processor 250 records a RAW file in which RAW data subjected to image processing by the primary image processing circuit 220 of the second image processing engine 210 is RAW data for static image recording, the RAW file having lossless-compressed or uncompressed RAW data held in the primary memory 240, in a folder in the image recording unit 260 associated with terminal information or user information of the imaging terminal 100.

It should be noted that the second processor 250 may record at least one of the static image file or the RAW file in the image recording unit 260.

In addition, the digital camera 100a continuously images, in a case where a bracket imaging mode or a continuous shooting mode is set, a plurality of static images by operating the shutter button once. In this case, server 200 records a plurality of static image files and/or the RAW data after the image processing in the image recording unit 260.

Further, in a case where recording instruction or recording end instruction of a video by a user operation of the shutter button is received in a case where a video mode is set, the digital camera 100a transmits recording instruction information or recording end instruction information from the first communication unit 124 to the server 200. The server 200 (the second image processing engine 210) performs image processing for video recording on continuous data received in a period from the reception of the recording instruction information of the video to the reception of the recording end instruction information of the video, and stores a video file having video data generated by the image processing in the primary memory 240, and the second processor 250 records the video file stored in the primary memory 240 in the image recording unit 260.

Meanwhile, the imaging terminal 100 is in a state of constantly being connected to the server 200 even in a case where the imaging terminal 100 is activated in the playback mode or is switched from the imaging mode to the playback mode, and in a case where the user performs playback operation in accordance with displayed contents of the operation unit 114 and the LCD 118, the imaging terminal 100 outputs a playback request corresponding to the contents of the operation from the first communication unit 124 to the server 200.

In a case where the playback request is received via the second communication unit 202, the server 200 (the second processor 250) reads out an image file corresponding to the playback request from the image recording unit 260, and expands the compressed image data in the image file to transmit the image data from the second communication unit 202 to the imaging terminal 100 as a playback image. In a case where the image file corresponding to the playback request is a RAW file, the server 200 performs the RAW development processing on the RAW data in the RAW file, and then transmits the image file from the second communication unit 202 to the imaging terminal 100 as a playback image.

For example, the imaging terminal 100 transmits a playback request of the latest captured image, in a case where the imaging terminal 100 is activated in the playback mode, or in a case where the imaging terminal 100 is switched from the imaging mode to the playback mode, and the server 200 reads out a corresponding image file from the image recording unit 260, expands compressed image data in the image file, and transmits the image data from the second communication unit 202 to the imaging terminal 100 as a playback image in a case where the server 200 receives the playback request of the latest captured image from the imaging terminal 100.

The imaging terminal 100 that has received the playback image displays the playback image on the LCD 118 via the display control unit 116. Thereafter, in a case where the user performs playback operation such as frame advance, frame return, or the like by using the operation unit 114, the imaging terminal 100 transmits a playback request corresponding to the playback operation to the server 200, and the server 200 reads out an image file corresponding to the received playback request from the image recording unit 260 and transmits the playback image to the imaging terminal 100 in the same manner as described above.

In addition, in a case in which the imaging terminal 100 requests a list of thumbnail images of a image file group of the user recorded in the image recording unit 260, the server 200 transmits a list of thumbnail images corresponding to the request to the imaging terminal 100. Then, the imaging terminal 100 that has received the list of the thumbnail images can display the list of the thumbnail images on the LCD 118.

The user operates the operation unit 114 to select a desired thumbnail image while viewing the list of thumbnail images displayed on the LCD 118, and thus, the imaging terminal 100 can transmit a playback request (playback request accompanied by image file name) for an image corresponding to the selected thumbnail image to the server 200. In a case where the playback request accompanied by an image file name is received from the imaging terminal 100, the server 200 reads out an image file corresponding to the image file name from the image recording unit 260 and transmits the playback image to the imaging terminal 100 in the same manner as described above. As a result, the playback image corresponding to the thumbnail image selected by the user is displayed on the LCD 118 of the imaging terminal 100.

Further, the user can specify an image to be printed by using the playback image or the thumbnail image, and can cause the imaging terminal 100 to transmit a print request (print request accompanied by image file name) for the specified image to the server 200. In a case where a printing request accompanied by an image file name is received from the imaging terminal 100, the server 200 can perform printing service by reading out an image file corresponding to the image file name from the image recording unit 260 and by transmitting the image file to a print server (not shown).

In the above example, a case where a static image is played back has been described, but the same can also be applied to a case where a video is played back.

Furthermore, the user can perform image editing (revision, correction, processing) such as addition of a filter effect via the network by using a utility software (retouch software) in the server 200 while checking the edited image (playback image) in real time.

### [Imaging System]

### First Embodiment of Imaging System

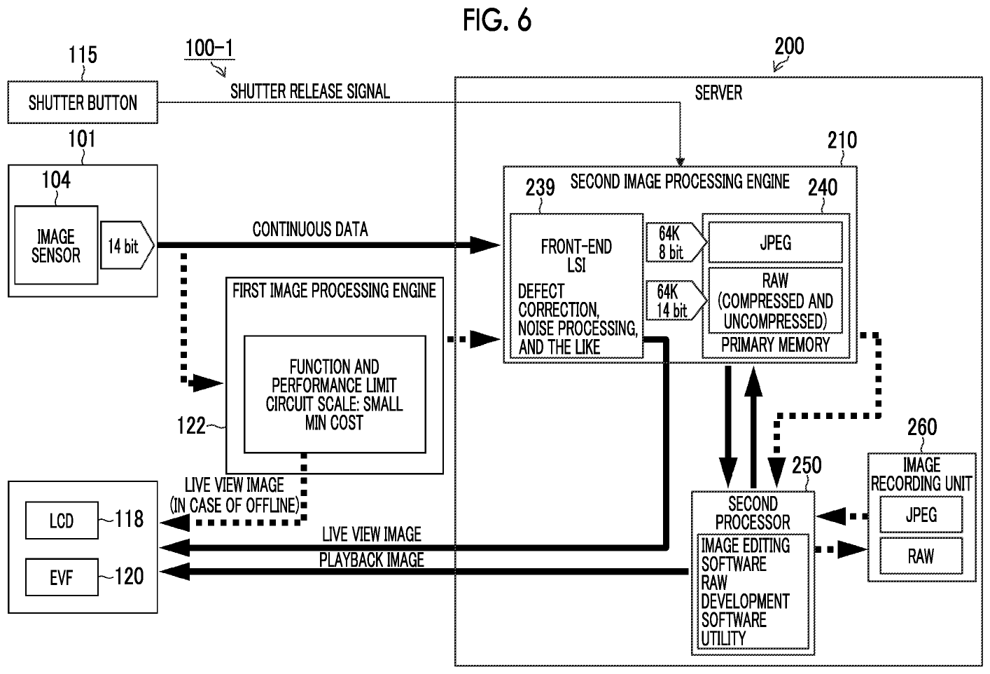

FIG. 6 is a schematic diagram showing a first embodiment of the imaging system according to the present invention.

In FIG. 6, a solid-line arrow indicates a flow of data in a case where communication between an imaging terminal 100-1 and the server 200 is normal, and a dotted-line arrow indicates a flow of data in a case where communication between the imaging terminal 100-1 and the server 200 is not available (including a case where the communication is unstable). In addition, in FIG. 6, a communication unit and the like of the imaging terminal 100-1 and the server 200 are omitted.

Hereinafter, a case where communication between the imaging terminal 100-1 and the server 200 is normal will be described.

In this case, the imaging terminal 100-1 is constantly connected to the server 200 via the wireless access point 310 and the network 300 (FIG. 1) during activation, and in the imaging mode, the RAW data before the image processing is transmitted to the server 200 in the format of continuous data. The front-end LSI 239 of the second image processing engine 210 of the server 200 generates a live view image from the continuous data consisting of the received RAW data, and the server 200 transmits the live view image generated by the front-end LSI 239 to the imaging terminal 100-1.

The imaging terminal 100-1 that has received the live view image displays the live view image on the LCD 118 or the EVF 120.

As a result, the user can determine the composition or the like while viewing the live view image, and can perform the imaging operation of the desired subject by pressing the shutter button 115. In a case where the shutter button 115 is pressed (in a case where an imaging instruction to capture a static image by a user operation is received), the imaging terminal 100-1 transmits the RAW data for static image recording having 14-bit gradation read out from the image sensor 104 as one frame of the continuous data and transmits a shutter release signal to the server 200 by interrupting the continuous data.

The second image processing engine 210 (front-end LSI 239) of the server 200 performs image processing on the RAW data for static image recording received in correspondence with the shutter release signal. That is, the front-end LSI 239 performs RAW development processing on the received RAW data for static image recording, stores the static image file having JPEG-compressed image data (8-bit gradation) having 8-bit gradation in the primary memory 240, and/or stores a RAW file having lossless-compressed or uncompressed RAW data (14-bit gradation) which is the received RAW data for static image recording subjected to the image processing by the primary image processing circuit 220 (FIG. 3), in the primary memory 240.

The second processor 250 of the server 200 records the static image file having 8-bit gradation and/or the RAW file having 14-bit gradation, which is stored in the primary memory 240, in the image recording unit 260.

Meanwhile, in a case where the imaging terminal 100-1 is activated in the playback mode or is switched from the imaging mode to the playback mode, and in a case where the user performs the playback operation in accordance with the display contents of the operation unit 114 and the LCD 118, the imaging terminal 100-1 outputs a playback request corresponding to the contents of the operation from the first communication unit 124 to the server 200.

In a case where a playback request is received from the imaging terminal 100-1, the server 200 reads out an image file corresponding to the playback request from the image recording unit 260, expands compressed image data in the image file, and transmits the image file from the second communication unit 202 to the imaging terminal 100 as a playback image. In a case where the image file corresponding to the playback request is a RAW file, the RAW data of the RAW file is subjected to RAW development processing and then transmitted to the imaging terminal 100 as a playback image.

The imaging terminal 100-1 that has received the playback image displays the playback image on the LCD 118 via the display control unit 116.

Next, a case where communication between the imaging terminal 100-1 and the server 200 is not available (a case of offline) will be described.

In a case of offline, the first image processing engine 122 of the imaging terminal 100-1 is operated to enable the imaging by the imaging terminal 100-1 alone.

The RAW data read out from the image sensor 104 at a predetermined frame rate (for example, 30 fps or 60 fps) is output to the first image processing engine 122.

As described above, the first image processing engine 122 has a technical specification different from the second image processing engine 210 of the server 200, has limited function and performance as compared with the second image processing engine 210, and also has a small and inexpensive circuit scale.

The first image processing engine 122 converts continuous data consisting of RAW data having 14-bit gradation from the image sensor 104 into, for example, RAW data having 8-bit gradation, and then performs image processing such as RAW development processing, on the RAW data having 8-bit gradation to generate a live view image. The live view image may have a lower image quality (resolution, display frame rate) as compared with the live view image generated by the second image processing engine 210 in a case where the communication is normal.

Then, in a case where the shutter button 115 is pressed, the first image processing engine 122 performs image processing on the RAW data for static image recording read out from the image sensor 104 when the shutter button 115 is pressed, generates image data for static image recording, and records the image data in an internal memory (not shown).

In a case where communication between the imaging terminal 100-1 and the server 200 becomes normal, the imaging terminal 100-1 transmits the image data recorded in the internal memory of the first image processing engine 122 to the server 200, before transmission of the continuous data. The second image processing engine 210 performs image processing, such as noise reduction processing for improving image quality, on the received image data. The second processor 250 records an image file in which image data is subjected to image processing by the second image processing engine 210 and the image data is filed, in the image recording unit 260.

The first image processing engine 122 of the imaging terminal 100-1 is an auxiliary image processing engine used for emergency evacuation in a case where communication between the imaging terminal 100-1 and the server 200 is not available. Therefore, the first image processing engine 122 has a significantly small circuit scale, function thereof is limited to minimum necessary function, such as being able to deal with only data having 8-bit gradation, and a part of the primary image processing such as noise reduction processing for improving image quality does not need to be state-of-the-art. Therefore, the circuit scale can be set to a cost of one tenth to several tenths of a cost of the second image processing engine 210 of the server 200. In addition, a usage frequency of the first image processing engine 122 in the imaging terminal 100-1 is almost not in an area where a communication network is developed, so that a demerit in terms of performance is unlikely to occur. The minimum image data for recording is recorded, so that the imaging is not completely impossible in a case where the communication is temporarily interrupted or the like. Accordingly, since an operation, a display (live view image), or an image recording related to imaging can be performed, a shutter chance is not missed. In a case where a continuous shooting function is emphasized, a minimum memory for a continuous shooting may be provided, and in this case, the function is limited to 5-frame continuous shooting or the like with respect to normal 100-frame continuous shooting, but the continuous shooting can be performed.

The imaging terminal 100-1 can play back and display only an image recorded in the internal memory of the first image processing engine 122 in a case of offline, and cannot play back and display an image recorded in the image recording unit 260.

### Second Embodiment of Imaging System

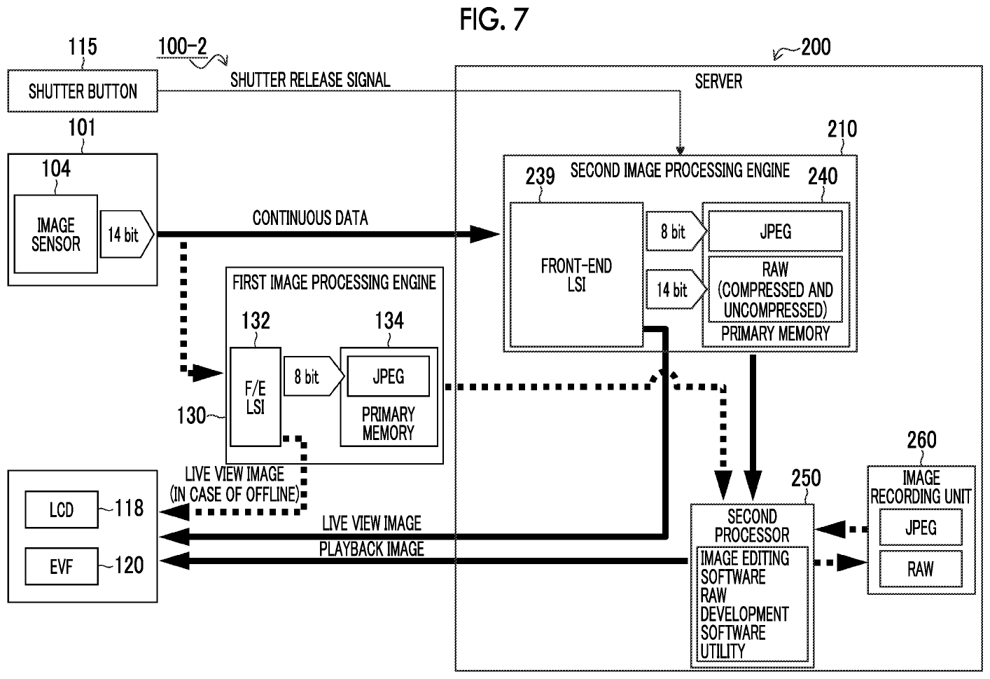

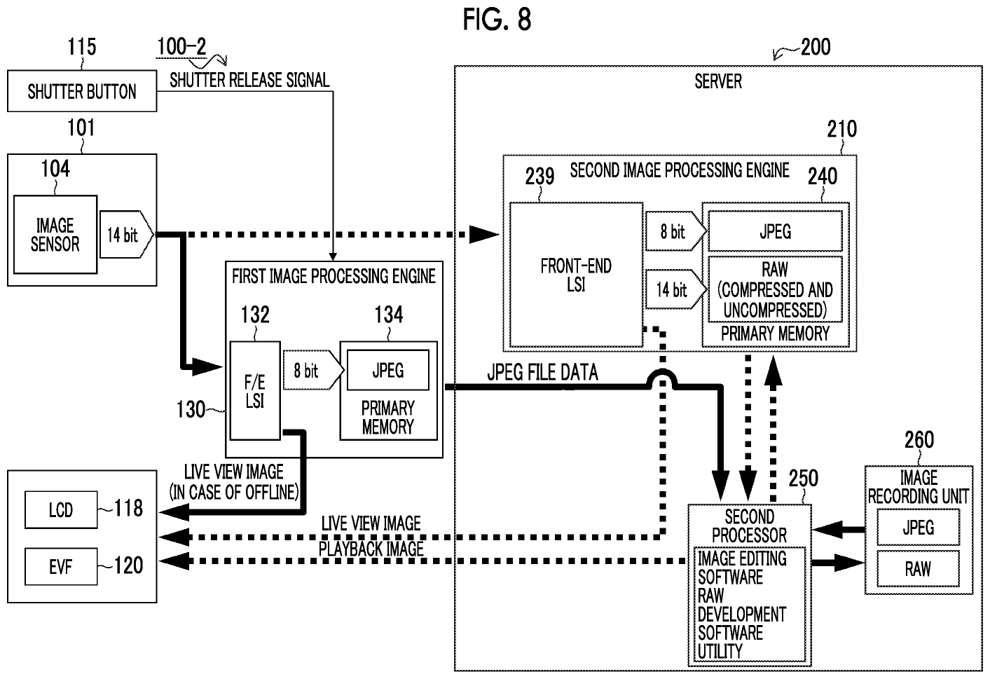

FIGS. 7 and 8 are schematic diagrams respectively showing a second embodiment of the imaging system according to the present invention, FIG. 7 shows a case where communication between the imaging terminal and the server is normal, and FIG. 8 shows a case where communication between the imaging terminal and the server is not available (a case of offline).

In FIGS. 7 and 8, the same reference numerals are given to the components that are common to the first embodiment of the imaging system shown in FIG. 6, and a detailed description thereof will be omitted.

In the second embodiment of the imaging system shown in FIGS. 7 and 8, the imaging terminal 100-2 is different from the imaging terminal 100-1 of the first embodiment of the imaging system shown in FIG. 6, and particularly, a first image processing engine 130 is different.

The first image processing engine 130 of the imaging terminal 100-2 operates in a case of offline. Therefore, in a case where communication between the imaging terminal 100-2 and the server 200 is normal, the second embodiment of the imaging system shown in FIGS. 7 and 8 performs the same operation as the first embodiment of the imaging system shown in FIG. 6.

Hereinafter, a case where the imaging terminal 100-2 is offline will be described.

The first image processing engine 130 of the imaging terminal 100-2 that operates in a case of offline includes a front-end LSI 132 and a primary memory 134 which is an internal memory.

The front-end LSI 132 has a lower technical specification as compared with the front-end LSI 239 of the second image processing engine 210 of the server 200, has limited functions and performance, and has a small and inexpensive circuit scale.

The front-end LSI 132 converts continuous data consisting of RAW data having 14-bit gradation from the image sensor 104 into, for example, RAW data having 8-bit gradation, and then performs image processing such as RAW development processing, on the RAW data having 8-bit gradation to generate a live view image. The live view image may have a lower image quality (resolution, display frame rate) as compared with the live view image generated by the front-end LSI 239 of the second image processing engine 210 in a case where the communication is normal.

The live view image generated by the front-end LSI 132 is output to the LCD 118 or the EVF 120 and displayed as indicated by a solid-line arrow in FIG. 8.

Then, in a case where the shutter button 115 is pressed, the front-end LSI 132 performs RAW development processing and image processing including JPEG compression on the RAW data for static image recording read out from the image sensor 104 when the shutter button 115 is pressed, and records an image file having the JPEG-compressed image data in the primary memory 134.

The image quality of image data for static image recording generated by the front-end LSI 132 is lower than the image quality (at least one or more of an image size, resolution, color reproducibility, or the like) of the image data for static image recording generated by the front-end LSI 239 of the server 200. The first image processing engine 130 having the front-end LSI 132 does not include image processing, for example, such as noise processing, defect correction, and image quality enhancement as compared with the second image processing engine 210 having the front-end LSI 239, and the reason for this is an inexpensive price of the first image processing engine 130.

Meanwhile, in a case where the communication between the imaging terminal 100-2 and the server 200 becomes normal, the imaging terminal 100-2 transmits the image file recorded in the primary memory 134 which is an internal memory of the first image processing engine 130 to the server 200, before transmission of the continuous data.

In a case where the image file is received from the imaging terminal 100-2, the server 200 (second processor 250) records the received image file in the image recording unit 260. As in the first embodiment of the imaging system shown in FIG. 6, the image data of the received image file may be reprocessed by the second image processing engine 210 and then recorded in the image recording unit 260.

### Third Embodiment of Imaging System

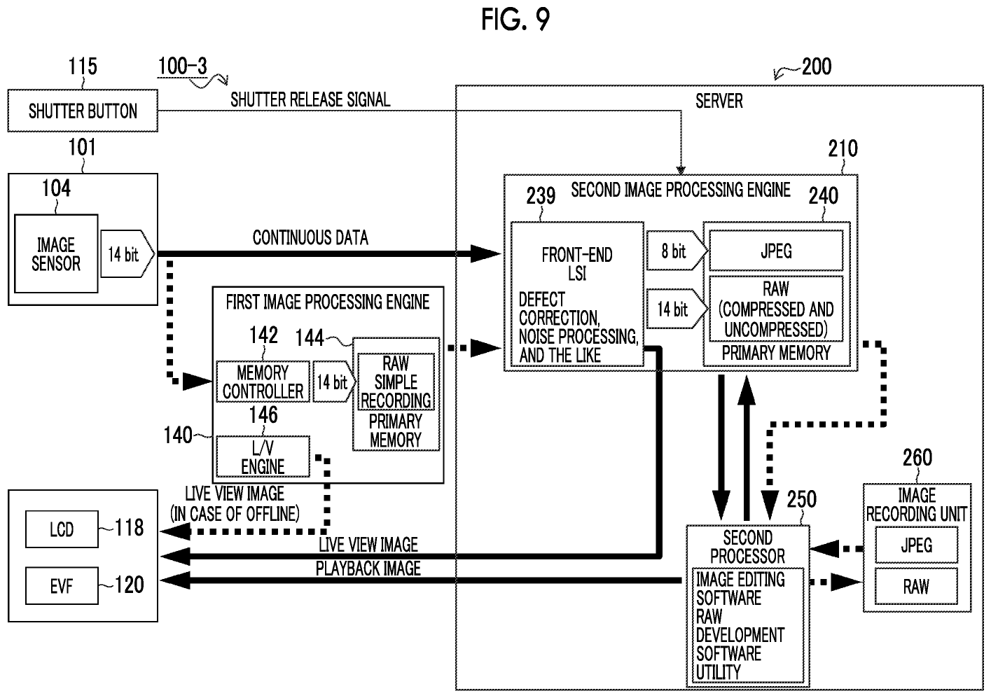

FIG. 9 is a schematic diagram showing a third embodiment of the imaging system according to the present invention.

In FIG. 9, the same reference numerals are given to the components that are common to the first embodiment of the imaging system shown in FIG. 6, and a detailed description thereof will be omitted.

In the third embodiment of the imaging system shown in FIG. 9, the imaging terminal 100-3 is different from the imaging terminal 100-1 of the first embodiment of the imaging system shown in FIG. 6, and particularly, a first image processing engine 140 is different.

The first image processing engine 140 of the imaging terminal 100-3 operates in a case of offline. Therefore, in a case where communication between the imaging terminal 100-3 and the server 200 is normal, the third embodiment of the imaging system shown in FIG. 9 performs the same operation as the first embodiment of the imaging system shown in FIG. 6.

Hereinafter, a case where the imaging terminal 100-3 is offline will be described.

The first image processing engine 140 of the imaging terminal 100-3 that operates in a case of offline comprises a memory controller 142, a primary memory 144 that is an internal memory, and a live view engine 146.

The first image processing engine 140 has a minimum image processing function in a case of offline.

The live view engine 146 converts continuous data consisting of RAW data having 14-bit gradation from the image sensor 104 into, for example, RAW data having 8-bit gradation, and then performs image processing such as RAW development processing, on the RAW data having 8-bit gradation to generate a live view image. The live view engine 146 may generate a live view image having a minimum image quality required for framing, image processing such as, for example, noise processing, defect correction, and image quality enhancement may be omitted, and may have a lower image quality (resolution, display frame rate) as compared with the live view image generated by the front-end LSI 239 of the second image processing engine 210.

The live view image generated by the live view engine 146 in a case of offline is output to the LCD 118 or the EVF 120 and displayed as indicated by a dotted-line arrow in FIG. 9.

Thereafter, in a case where the shutter button 115 is pressed, the memory controller 142 temporarily records the RAW data for static image recording for one frame having 14-bit gradation, which is read out from the image sensor 104 when the shutter button 115 is pressed, in the primary memory 144. In a case where the bracket imaging mode or the continuous shooting mode is set, the memory controller 142 temporarily records RAW data of a plurality of frames for static image recording that is continuously read out from the image sensor 104, in the primary memory 144 by a single shutter release operation of the shutter button 115. In addition, the live view engine 146 can continuously generate the live view images regardless of the shutter release operation of the shutter button 115.

Meanwhile, in a case where the communication between the imaging terminal 100-3 and the server 200 becomes normal, the imaging terminal 100-3 transmits the RAW data for static image recording having 14-bit gradation recorded in the primary memory 144 of the first image processing engine 140 to the server 200, before transmission of the continuous data.

In a case where the RAW data for static image recording captured in a case of offline is received from the imaging terminal 100-2, the server 200 (the front-end LSI 239 of the second image processing engine 210) performs image processing for static image recording on the received RAW data, and stores the RAW data in the primary memory 240.

The second processor 250 records the static image file having 8-bit gradation and/or the RAW file which has 14-bit gradation and is subjected to the primary image processing stored in the primary memory 240 in the image recording unit 260.

The image processing by the front-end LSI 239 with respect to the RAW data for static image recording captured in a case of offline can be performed as the same image processing as image processing with respect to the RAW data for static image recording received corresponding to the shutter release signal in a case where the communication between the imaging terminal 100-3 and the server 200 is normal.

### Fourth Embodiment of Imaging System

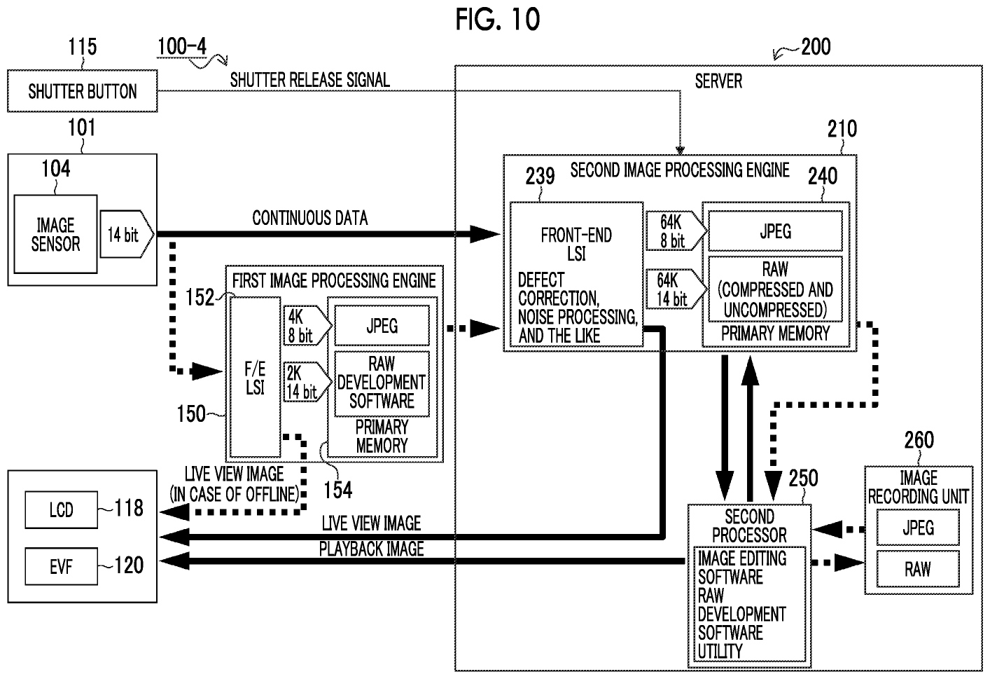

FIG. 10 is a schematic diagram showing a fourth embodiment of the imaging system according to the present invention.

In FIG. 10, the same reference numerals are given to the components that are common to the first embodiment of the imaging system shown in FIG. 6, and a detailed description thereof will be omitted.

In the fourth embodiment of the imaging system shown in FIG. 10, the imaging terminal 100-4 is different from the imaging terminal 100-1 of the first embodiment of the imaging system shown in FIG. 6, and particularly, the first image processing engine 150 is different.

The first image processing engine 150 of the imaging terminal 100-4 operates in a case of offline. Therefore, in a case where communication between the imaging terminal 100-4 and the server 200 is normal, the fourth embodiment of the imaging system shown in FIG. 10 performs the same operation as the first embodiment of the imaging system shown in FIG. 6.

Hereinafter, a case where the imaging terminal 100-4 is offline will be described.

The first image processing engine 150 of the imaging terminal 100-4 that operates in a case of offline comprises a front-end LSI 152 and a primary memory 154 that is an internal memory.

The first image processing engine 150 (front-end LSI 152) converts continuous data consisting of RAW data having 14-bit gradation from the image sensor 104 into, for example, RAW data having 8-bit gradation, and then performs image processing such as RAW development processing, on the RAW data having 8-bit gradation to generate a live view image. The live view engine 146 may be able to generate a live view image having the minimum image quality required for framing.

The live view image generated by the live view engine 146 in a case of offline is output to the LCD 118 or the EVF 120 and displayed as indicated by a dotted-line arrow in FIG. 10.

Thereafter, in a case where the shutter button 115 is pressed, the front-end LSI 152 performs image processing on the RAW data for static image recording for one frame having 14-bit gradation, which is read out from the image sensor 104 when the shutter button 115 is pressed.

The front-end LSI 152 performs image processing including RAW development processing and JPEG compression on the input RAW data, records an image file having the JPEG-compressed image data in the primary memory 134, and/or reduces a data amount (in the present example, an image size) of the input RAW data, and records the RAW data with the reduced data amount in the primary memory 134.

The first image processing engine 150 including the front-end LSI 152 is an auxiliary image processing engine used for emergency evacuation. Therefore, the first image processing engine 150 has a significantly small circuit scale, function thereof is limited to minimum necessary function, such as being able to deal with a certain image size (for example, image size of 4K size) or less, and a part of the primary image processing such as noise reduction processing for improving image quality does not need to be state-of-the-art. Therefore, the circuit scale can be set to be one tenth to several tenths of the size of the second image processing engine 210 on the network.

In addition, a usage frequency of the first image processing engine 150 of the imaging terminal 100-4 is almost not in an area where a communication network is developed, so that a demerit in terms of performance is unlikely to occur in a case of using only for purpose such as uploading to social networking service (SNS) or the like. In addition, since an operation, display (display of the live view image), or image recording related to imaging can be performed, a shutter chance is not missed, and the problem can be solved by a minimum additional circuit (first image processing engine). In a case where a continuous shooting function is emphasized, a minimum memory for a continuous shooting may be provided, and in this case, the function is limited to 5-frame continuous shooting or the like with respect to normal 100-frame continuous shooting, but the continuous shooting can be performed.

The front-end LSI 152 performs image processing including RAW development processing and JPEG compression on the input RAW data, but the JPEG compression may be omitted. Further, in a case where the RAW data with the reduced data amount is recorded in the primary memory 134, the front-end LSI 152 can reduce the data amount, for example, by setting the number of bits of the RAW data having 14-bit gradation to less than 14 bits (for example, 8 bits) in addition to reducing an image size of a 2K size.

Meanwhile, in a case where communication between the imaging terminal 100-4 and the server 200 becomes normal, the imaging terminal 100-4 transmits the data recorded in the primary memory 144 of the first image processing engine 140 to the server 200, before transmission of the continuous data.

In a case where the RAW data for recording a static image captured in a case of offline is received from the imaging terminal 100-4, the server 200 (the front-end LSI 239 of the second image processing engine 210) performs image processing for static image recording on the received data, and stores the data in the primary memory 240.

The second processor 250 records the image stored in the primary memory 240 in the image recording unit 260.

### [Action of Imaging System]

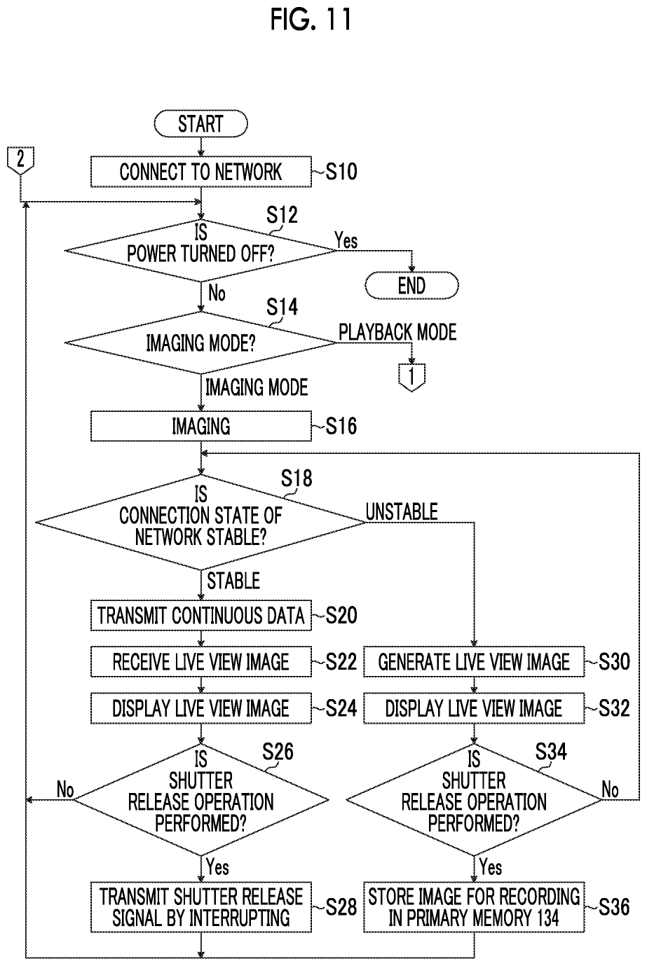

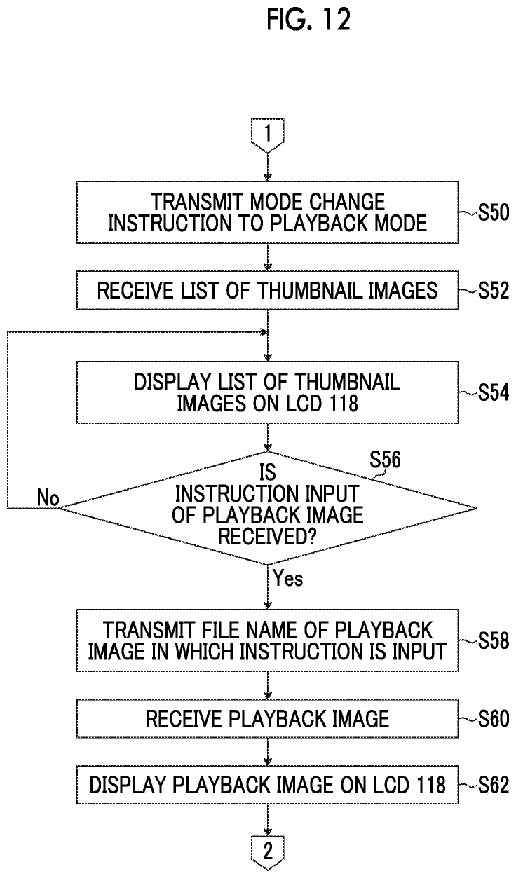

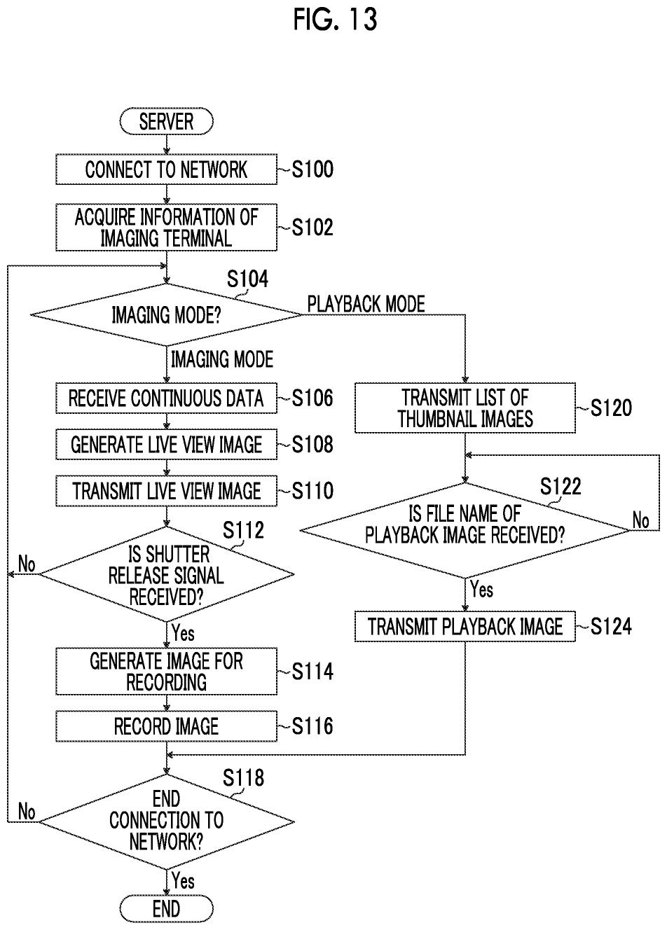

FIGS. 11 and 12 are flowcharts showing operations of the imaging terminal in the imaging system, and FIG. 13 is a flowchart showing an operation of the server in the imaging system.

The flowcharts shown in FIGS. 11 and 12 show an operation procedure of the imaging terminal 100-2 of the second embodiment of the imaging system shown in FIGS. 7 and 8. Further, it is assumed that the imaging terminal 100-2 is a digital camera 100a with communication function shown in FIGS. 1 and 2.

### <Operation of Imaging Terminal>

In FIG. 11, in a case where the power switch is turned on, the imaging terminal 100-2 (digital camera 100a with communication function) first performs connection processing of the network to be constantly connected to the server 200 (step S10).

Subsequently, the digital camera 100a (first processor 110) determines whether or not the power switch is turned off (step S12). In a case where the power is turned off (in a case of “Yes”), the operation of the digital camera 100a ends, and in a case where the power is turned on (in a case of “No”), a transition to step S14 is performed.

In step S14, it is determined whether the operation mode of the digital camera 100a is an imaging mode or a playback mode (step S14). In a case where it is determined that the operation mode is the imaging mode, a transition to step S16 is performed, and in a case where the imaging operation is performed and it is determined that the operation mode is the playback mode, a transition to image playback processing shown in FIG. 12 is performed.

In step S16, the imaging unit 101 (image sensor 104) performs the imaging at a predetermined frame rate, and the RAW data before the image processing is read out from the image sensor 104 as continuous data at a predetermined frame rate.

Next, the digital camera 100a (first processor 110) determines whether or not a connection state of the network subjected to the connection processing in step S10 is stable (step S18). In a case where it is determined that the network connection is stable, the digital camera 100a transmits the continuous data read out from the image sensor 104 to the server 200 via the first communication unit 124 (step S20).

As will be described below, the server 200 performs image processing such as RAW development processing on the continuous data received from the digital camera 100a to generate a live view image and transmits the generated live view image to the digital camera 100a.

The digital camera 100a receives the live view image transmitted from the server 200 via the first communication unit 124 (step S22) and displays the received live view image on the LCD 118 or the EVF 120 (step S24). Here, since a delay of the transmission of the continuous data and the reception of the live view image is so short that a human cannot experience the delay, the live view image can be displayed on the LCD 118 or the EVF 120 in real time.

Subsequently, the digital camera 100a (first processor 110) determines whether or not the shutter release operation of the shutter button 115 by the user is performed (step S26). In step S26, in a case where it is determined that the shutter release operation is not performed (in a case of “No”), a transition to step S12 is performed. As a result, the processing of step S12 to step S26 is repeated to display the live view image.

In step S26, in a case where it is determined that the shutter release operation is performed (in a case of “Yes”), a transition to step S28 is performed. In step S25, the digital camera 100a transmits the shutter release signal to the server 200 via the first communication unit 124 by interrupting the continuous data, and then a transition to step S12 is performed. The operation of the server 200 that has received the shutter release signal will be described below.

On the other hand, in step S18, in a case where it is determined that the network connection is unstable (including a case where communication is not available), the digital camera 100a enables the first image processing engine 130 to operate, and outputs the continuous data read out from the image sensor 104 to the first image processing engine 130. The first image processing engine 130 performs the image processing, such as the RAW development processing, on the input continuous data to generate a live view image (step S30). The first image processing engine 130 outputs the generated live view image to the LCD 118 or the EVF 120 to display the live view image (step S32).

Subsequently, the digital camera 100a (first processor 110) determines whether or not the shutter release operation of the shutter button 115 by the user is performed (step S32). In step S32, in a case where it is determined that the shutter release operation is not performed (in a case of “No”), a transition to step S18 is performed. As a result, the processing of step S18 to step S34 is repeated to display the live view image.

In step S34, in a case where it is determined that the shutter release operation is performed (in a case of “Yes”), a transition to step S36 is performed. In step S36, the first image processing engine 130 performs the image processing including the RAW development processing and the JPEG compression on the RAW data having the 14-bit gradation for static image recording corresponding to the shutter release signal, and stores (records) the image file having the JPEG-compressed image data in the primary memory 134. Then, the digital camera 100a transitions to step S12.

On the other hand, in step S14, in a case where it is determined that the operation mode is the playback mode, a transition to step S50 shown in FIG. 12 is performed. In step S50, the digital camera 100a transmits a mode change instruction to the playback mode to the server 200 via the first communication unit 124. Needless to say, the transmission of the continuous data from the digital camera 100a is stopped.

As described below, in a case where a mode change instruction to the playback mode is received, the server 200 transmits a list of thumbnail images to the digital camera 100a that has transmitted the mode change instruction, and the digital camera 100a receives the list of thumbnail images via the first communication unit 124 (Step S52).

In a case where the list of thumbnail images is received from the server 200, the digital camera 100a displays the received list of thumbnail images on the LCD 118 (step S54).

The user can operate the operation unit 114 to select a desired thumbnail image as the playback image while viewing the list of thumbnail images displayed on the LCD 118. The digital camera 100a determines whether or not the selection instruction input of the playback image by the user operation on the operation unit 114 is received (step S56).

In step S56, in a case where the determination is made that the selection instruction input of the playback image has been received, the digital camera 100a transmits a playback request (playback request accompanied by an image file name) of the image corresponding to the selected thumbnail image to the server 200 via the first communication unit 124 (step S58). In a case where the playback request accompanied by the image file name is received from the digital camera 100a, the server 200 reads out the playback image corresponding to the image file name from the image recording unit 260 and transmits the playback image to the digital camera 100a. The digital camera 100a receives the playback image corresponding to the playback request from the server 200 via the first communication unit 124 (step S60).

The digital camera 100a displays the playback image received from the server 200 on the LCD 118 (step S62), and transitions to step S12 in FIG. 11.

In a case where the playback mode is maintained, the digital camera 100a can display the playback image corresponding to the playback request on the LCD 118. The digital camera 100a can display the playback image on an external display (not shown) connected via the interface.

### <Operation of Server>

In FIG. 13, in a case where a network is connected between the server 200 and the digital camera 100a (step S102), the digital camera 100a transmits terminal information indicating the digital camera 100a to the server 200 at a time of starting communication with the server 200, and the server 200 receives the terminal information of the digital camera 100a via the second communication unit 202 and acquires the terminal information (step S102).

Subsequently, the server 200 determines whether an operation mode of the digital camera 100a connected to the network is an imaging mode or a playback mode (step S104). In a case where it is determined that the operation mode is the imaging mode, a transitions to step S106 is performed, and in a case where it is determined that the operation mode is the playback mode, a transition to step S120 is performed.

In step S106, the RAW data at a predetermined frame rate is received as continuous data from the digital camera 100a. The second image processing engine 210 of the server 200 generates a live view image by performing the image processing, such as the RAW development processing, on the RAW data at a predetermined frame rate (step S108). The server 200 transmits the live view image generated by the second image processing engine 210 to the digital camera 100a via the second communication unit 202 (step S110).

Subsequently, the server 200 determines whether or not a shutter release signal has been received from the digital camera 100a (step S112). In a case where the shutter release signal is received (in a case of “Yes”), the second image processing engine 210 performs image processing on the RAW data corresponding to the shutter release signal (imaging instruction information) among the continuous RAW data, and generates an image (static image) for recording (step S144).

In a case where the image processing including the RAW development processing is performed on the RAW data, the second image processing engine 210, based on the terminal information acquired in step S102, acquires necessary information (a color filter array, the number of pixels, pixel defect information, and other parameters of the image sensor 104) from a server of the manufacturer of the digital camera 100a to perform RAW development on the RAW data imaged by digital camera 100a, or acquires from the server of the manufacturer in advance and reads out and uses corresponding information out of the information stored in the recording unit.

The second processor 250 records an image for recording generated by the second image processing engine 210 in the image recording unit 260 (step S116).

Subsequently, the server 200 determines whether or not the network connection to the digital camera 100a is ended (step S118), transitions to step S104 in a case where the network connection is not ended, and ends the processing performed on the digital camera 100a in the server 200 in a case where the network connection is ended.

On the other hand, in step S104, in a case where it is determined that the operation mode of the digital camera 100a is a playback mode, the server 200 generates a list of thumbnail images of the images captured by the digital camera 100a and recorded in the image recording unit 260, and transmits the list of thumbnail images to the digital camera 100a (step S120). The server 200 can specify an image folder corresponding to the digital camera 100a of the image recording unit 260 based on the terminal information acquired in step S102, and can create a list of thumbnail images corresponding to the digital camera 100a based on an image file stored in the specified image folder.

Subsequently, the server 200 determines whether or not the playback request (playback request accompanied by the image file name) is received from the digital camera 100a (step S122), and in a case where the playback request is received, reads out a playback image corresponding to the playback request from the image recording unit 260 and transmits the read out playback image to the digital camera 100a (step S124).

### [Others]

In a case where the imaging terminal 100 is the smartphone 100b with a camera built therein, the operation unit is a graphical user interface (GUI) mainly including a screen of the smartphone 100b, a touch panel on the screen, and a GUI controller, and the shutter release operation can be performed by touching an icon of the shutter button.

In addition, in the present embodiment, the AF control and the AE control in the imaging terminal are performed independently by the imaging terminal. However, a server that receives a continuous data from the imaging terminal may generate control information required for the AF control and the AE control based on the continuous data, and may transmit the generated control information to the imaging terminal, such that the imaging terminal performs the AF control and the AE control.

The server is not physically limited to one server, and different servers may perform the processing in accordance with a content of the processing in the server, and a plurality of servers may cooperate to perform the processing even the content of the processing is the same.

In addition, in the present embodiment, for example, a hardware structure of a processing unit that executes various types of processing, such as the first processor 110 of the digital camera 100a, the first image processing engine 122, the second processor 250 of the server 200, and the second image processing engine 210, corresponds to the following various processors. The various processors include a central processing unit (CPU) that is a general-purpose processor functioning as various processing units by executing software (program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be configured by one of these various processors, or may be configured by two or more same type or different types of processors (for example, a plurality of FPGAs or a combination of the CPU and the FPGA). Moreover, a plurality of processing units may be configured by one processor. As an example of a plurality of processing units composed of one processor, first, as represented by a computer such as a client or a server, a form in which one processor is composed of a combination of one or more CPUs and software and the processor functions as a plurality of processing units is possible. Second, as represented by a system on chip (SoC) or the like, a form of using a processor that implements functions of the entire system including a plurality of processing units in one integrated circuit (IC) chip is possible. As described above, the various processing units are constituted by using one or more of the various processors as the hardware structure.

Furthermore, the hardware structure of those various processors is more specifically an electric circuit (circuitry) in which circuit elements such as semiconductor elements are combined.

In addition, the present invention is not limited to the embodiment and can be subjected to various modifications without departing from a spirit of the present invention.

### EXPLANATION OF REFERENCES

1: imaging system
100: imaging terminal
100-1: imaging terminal
100-2: imaging terminal
100-3: imaging terminal
100-4: imaging terminal
100a: digital camera
100b: smartphone
101: imaging unit
102: imaging lens
104: image sensor
108: sensor driver
110: first processor
112: memory
114: operation unit
115: shutter button
116: display control unit
118: LCD
122: first image processing engine
124: first communication unit
130: first image processing engine
132: front-end LSI
134: primary memory
140: first image processing engine
142: memory controller
144: primary memory
146: live view engine
150: first image processing engine
152: front-end LSI
154: primary memory
200: server
202: second communication unit
210: second image processing engine
220: primary image processing circuit
221: offset processing circuit
222: pixel defect correction circuit
223: tone correction circuit
224: individual difference correction circuit
230: secondary image processing circuit
231: WB correction circuit
232: gamma correction circuit
233: demosaicing processing circuit
234: YC conversion circuit
235: contour highlighting circuit
236: color difference matrix circuit
237: compression circuit
239: front-end LSI
240: primary memory
250: second processor
260: image recording unit
300: network
310: wireless access point
S10 to S36, S50 to S62, S100 to S124: step

What is claimed is:

1. An imaging system comprising:
at least one or more imaging terminals; and
a server,
wherein the imaging terminal includes
an imaging unit that includes an image sensor and outputs imaging data,
a first communication unit that transmits the imaging data output from the imaging unit to the server,
a first image processing engine that performs image processing on the imaging data output from the imaging unit, and
a memory that stores an image subjected to the image processing by the first image processing engine, and
the server includes
a second communication unit that receives the imaging data transmitted from the first communication unit of the imaging terminal, and
a second image processing engine that performs image processing on the received imaging data and generates an image for recording, the second image processing engine being different from the first image processing engine of the imaging terminal.

2. The imaging system according to claim 1,
wherein the second image processing engine generates a live view image based on continuously received imaging data.

3. The imaging system according to claim 1,
wherein the server records the image for recording generated by the second image processing engine to an image recording unit.

4. The imaging system according to claim 1,
wherein the second image processing engine has a technical specification higher than a technical specification of the first image processing engine.

5. The imaging system according to claim 4,
wherein the first image processing engine and the second image processing engine have different image processing performance.

6. The imaging system according to claim 1,
wherein the first image processing engine is capable of the image processing on a smaller amount of information per pixel than the second image processing engine.

7. The imaging system according to claim 1,
wherein the first image processing engine has a different number of gradation bits or a different number of processing bits from the second image processing engine.

8. The imaging system according to claim 1,
wherein the first image processing engine has only a part among functions that are able to perform the image processing with compared to the second image processing engine.

9. The imaging system according to claim 1,
wherein the first image processing engine is capable of performing the image processing on a smaller number of pixels of an image than the second image processing engine.

10. The imaging system according to claim 1,
wherein the first image processing engine has an arithmetic element having smaller thermal design power than the second image processing engine.

11. The imaging system according to claim 1,
wherein the first image processing engine has an arithmetic element having a smaller number of transistors than the second image processing engine.

12. The imaging system according to claim 1,
wherein the first image processing engine has a smaller number of processor cores than the second image processing engine.

13. The imaging system according to claim 1,
wherein the first image processing engine includes an arithmetic element having a lower operation clock frequency than the second image processing engine.

14. The imaging system according to claim 1,
wherein the first image processing engine includes an arithmetic element having a lower rated operating current value than the second image processing engine.

15. The imaging system according to claim 1,
wherein the first image processing engine has a smaller cache memory capacity than the second image processing engine.

16. The imaging system according to claim 1,
wherein the first image processing engine has a configuration in which the number of executable commands is smaller than the second image processing engine.

17. The imaging system according to claim 1,
wherein the first image processing engine has a configuration in which the number of calculation units for executing a calculation command is smaller than the second image processing engine.

18. The imaging system according to claim 1,
wherein the first image processing engine has a built-in graphics function, and the second image processing engine has an extended graphics function.

19. The imaging system according to claim 1,
wherein the imaging terminal transmits, in a case where an imaging instruction of a static image by a user operation is received, imaging instruction information from the first communication unit to the server, and
the second image processing engine performs the image processing on imaging data corresponding to the imaging instruction information among continuous imaging data, and generates a static image for recording, in a case where the imaging instruction information is received via the second communication unit.

20. The imaging system according to claim 1,
wherein the imaging terminal transmits recording instruction information or recording end instruction information from the first communication unit to the server in a case where a recording instruction or a recording end instruction of a video by a user operation is received, and
the second image processing engine performs, in a case where the recording instruction information or the recording end instruction information is received via the second communication unit, image processing on imaging data from receiving recording instruction information to receiving recording end instruction information among the continuous imaging data, and generates a video for recording.

21. The imaging system according to claim 1,
wherein the imaging terminal transmits terminal information indicating the imaging terminal to the server at a time of starting communication with the server,
the server acquires, in a case where the terminal information is received, RAW development information corresponding to the received terminal information, and
the second image processing engine performs image processing of performing RAW development on the imaging data based on the acquired RAW development information.

22. The imaging system according to claim 2,
wherein the server transmits the live view image generated by the second image processing engine to the imaging terminal via the second communication unit, and
the imaging terminal displays the live view image on a display of the imaging terminal in a case where the live view image is received from the server via the first communication unit.

23. The imaging system according to claim 1,
wherein the first image processing engine is operated during a period in which communication between the imaging terminal and the server is not available.

24. The imaging system according to claim 1,
wherein the first image processing engine generates a live view image based on the imaging data continuously output from the image sensor during a period in which communication between the imaging terminal and the server is not available, and
the imaging terminal displays the live view image generated by the first image processing engine on a display during the period in which communication between the imaging terminal and the server is not available.

25. The imaging system according to claim 3,
wherein the imaging terminal communicates with the server, receives an image designated by a user operation among the images recorded in the image recording unit from the server, and displays the received image on a display or stores the received image in the memory.

26. An imaging system comprising:
at least one or more imaging terminals; and
a server,
wherein the imaging terminal includes
an imaging unit that includes an image sensor and outputs imaging data, and
a first communication unit that transmits the imaging data output from the imaging unit to the server,
the server includes
a second communication unit that receives the imaging data transmitted from the first communication unit of the imaging terminal, and
an image processing engine that performs image processing on the received imaging data to generate an image for recording,
data corresponding to one pixel of the image sensor of the imaging data has gradation of a maximum number of bits converted by an analog-to-digital conversion circuit,
the image processing engine generates a live view image based on continuously received imaging data,
the server transmits the generated live view image to the imaging terminal via the second communication unit, and
the imaging terminal displays the live view image on a display of the imaging terminal in a case where the live view image is received from the server via the first communication unit.

27. An imaging terminal comprising:
the imaging system according to claim 1.

28. A server comprising:
the imaging system according to claim 1.
